(19) United States
(12) Patent Application Publication
(10) Pub. No.: US 2025/0203157 A1
(43) Pub. Date: Jun. 19, 2025

(54) TELEVISION WITH VACANT ROOM DETECTION AND AUDIO-ONLY MODE

(71) Applicant: DISH Network Technologies India Private Limited, Bangalore (IN)

(72) Inventor: Rajashekhar Mandlur Basavarajappa, Bangalore (IN)

(21) Appl. No.: 18/540,536

(22) Filed: Dec. 14, 2023

(51) Int. Cl. H04N 21/442; G06F 3/14

(52) U.S. Cl. CPC H04N 21/44218; G06F 3/14

(57) ABSTRACT

An electronic apparatus having a display screen, a speaker, sensor circuitry, and control circuitry. A transceiver receives multimedia content. The multimedia content includes audio streaming that the transceiver converts into audio signals and also includes video streaming that the transceiver converts into video signals. The speaker receives the audio signals from the transceiver and converts the audio signals into audible sounds. The display screen receives video signals from the transceiver and converts the video signals into video. While the electronic apparatus is in operation within a target area, the sensor circuitry detects the presence or absence of any person within the target area. When the sensor circuitry detects the absence of any person within the target area, the control circuitry inhibits the display screen from presenting the video for viewing while permitting the speaker to emit the audible sounds.

### BACKGROUND

A smart television, also known as smart TV, is a television that is capable of processing multimedia content that the television receives from sources other than local television station over-the-air broadcasts.

### BRIEF DESCRIPTION OF THE DRAWINGS

The accompanying drawings, which are incorporated in and form a part of this specification, illustrate examples of the disclosure and, together with the description, explain principles of the examples. In the drawings, like reference symbols and numerals indicate the same or similar components.

FIGS. 1A and 1B illustrate an example of a television system consistent with the present disclosure.

FIG. 1C illustrates the example television system in a living space consistent with the present disclosure.

FIG. 2 is an example flowchart that illustrates detection processing by a television consistent with the present disclosure.

FIG. 3 is an example timing diagram that illustrates the detection processing by the television consistent with the present disclosure.

Like elements in the various figures are denoted by like reference numerals for consistency. It will be appreciated that the apparatus may vary as to configuration and as to details of the parts, and that the method may vary as to the specific steps and sequence, without departing from the basic concepts as disclosed herein.

More details on these and other examples and features are discussed in more depth below with regard to the figures.

### DETAILED DESCRIPTION

Viewing multimedia content on a smart television may result in various operating costs. These operating costs may include bandwidth costs associated with the receipt of the multimedia content by the smart television. These operating costs may also include energy costs associated with the operation of the smart television due, at least in part, to the large amount of energy typically consumed by the display screen while the smart television is in operation.

In many instances, the smart television may be in operation while someone is listening to audio emitted from the smart television without anyone being in an area where the smart television is located. Accordingly, there is a need in the art to decrease the operating costs of the smart television when someone is listening to the audio emitted from the smart television while no one is in the area where the smart television is located.

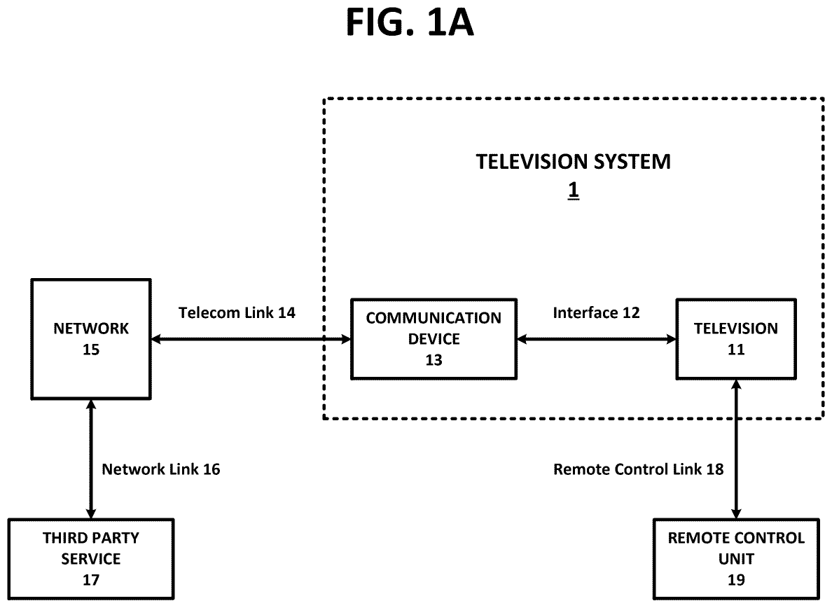

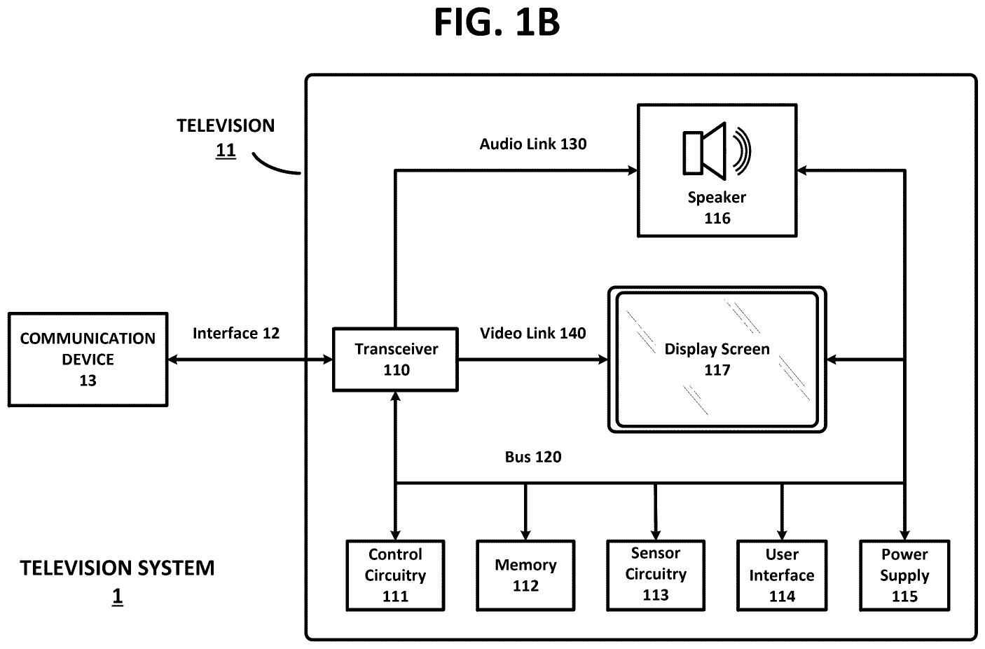

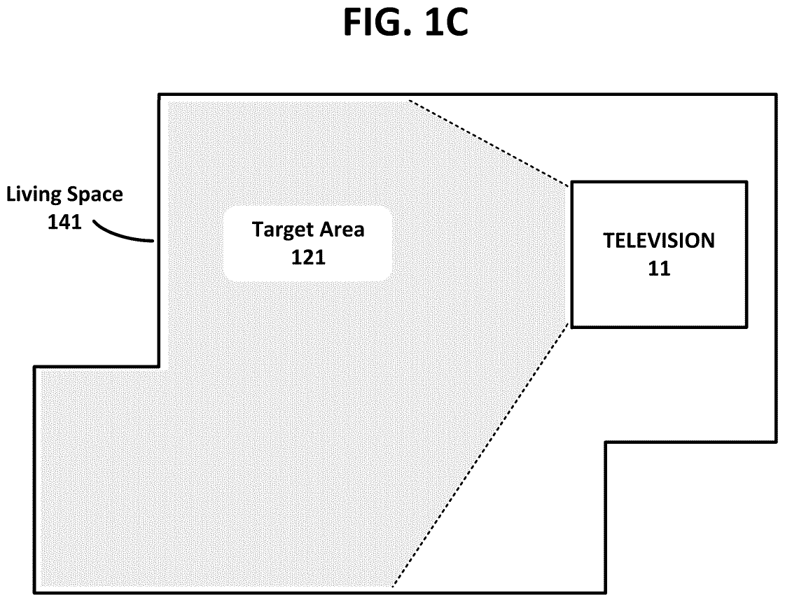

FIG. 1A illustrates an example of a television system 1. Components of the television system 1 may include a television 11 and a communication device 13. In some examples, the television 11 and the communication device 13 may be components that are separate and distinct from one another. In other examples, the television 11 and the communication device 13 may be integrated as a single unit and housed within an equipment enclosure. Those skilled in the art will appreciate that there may be additional components of the television system 1 that are not shown in FIG. 1A.

An interface 12 of FIG. 1A may be a communication link between the communication device 13 and the television 11. The interface 12 may include a wireless communication link and/or an electrical cable. The wireless communication link may transfer information wirelessly between the communication device 13 and the television 11. The electrical cable may comprise strands of wires and/or optical fibers that transfer information between the communication device 13 and the television 11. As will be explained in detail, the communication device 13 and the television 11 may exchange the information via the interface 12.

The communication device 13 is an electronic device that is capable of exchanging information between the television 11 and a network 15. The communication device 13 may comprise a set-top box, a digital video recorder (DVR), a modem, a wireless access point, a router, a gateway, a network switch, a set-back box, a control box, a television converter, a television recording device, a media player, an Internet streaming device, a mesh network node, a television tuner and/or any other electronic device that is capable of exchanging information between the television 11 and the network 15.

A telecom link 14 may be a communication link between the communication device 13 and the network 15. The communication device 13 and the network 15 may exchange the information and data via the telecom link 14. The telecom link 14 may include a wireless communication link and/or an electrical cable. The telecom link 14 may transfer information wirelessly between the communication device 13 and the network 15. The electrical cable may comprise strands of wires and/or optical fibers that transfer information between the communication device 13 and the network 15. As will be explained in detail, the communication device 13 and the network 15 may exchange the information via the telecom link 14.

The network 15 may include any infrastructure that facilitates a bidirectional exchange of information between a third-party service 17 and the communication device 13. The network 15 may comprise a core network, a cellular network, and/or any other communications network. The third-party service may be one of many third-party services that communicate electronically with the network 15. The third-party service 17 may include a streaming service, a media service, a media distribution system, the Internet, a cable television headend, and/or any other communication system that is capable of distributing multimedia content. Via a network link 16, the network 15 may receive the multimedia content from the third-party service 17 and deliver communication information to the third-party service 17. Via the telecom link 14, the network 15 may receive the communication information from the communication device 13 and transmit the multimedia content to the communication device 13.

FIG. 1B illustrates the example television 11 that is consistent with the present disclosure. The television 11 is an electronic apparatus that may include transceiver 110, control circuitry 111, memory 112, sensor circuitry 113, user interface 114, a power supply 115, speaker 116, and display screen 117. The television 11 may be a smart TV.

Bus 120 electronically interconnects the transceiver 110, the control circuitry 111, the memory 112, the sensor circuitry 113, the user interface 114, speaker 116 and the display screen 117. Those skilled in the art will appreciate that there may be additional circuitry in the television 11 that is not shown in FIG. 1B.

The transceiver 110 is electronic circuitry that may enable wired or wireless communication between the television 11 and the communication device 13. The transceiver 110 may establish duplex communication with the communication device 13. The duplex communication may be a full duplex mode of communication and/or a half-duplex mode of communication. The transceiver 110 may electronically connect the communication device 13 to the television 11. The transceiver 110 may transmit, to the communication device 13, data that the communication device 13 may upload (or upstream) to the network 15. Via the interface 12, the communication device 13 may transfer the multimedia content to the transceiver 110. The transceiver 110 may receive, from communication device 13, the multimedia content that the communication device 13 may download (or downstream) from the network 15. The transceiver 110 may extract, from the multimedia content, audio streaming and video streaming. The video streaming may comprise the audio streaming combined with video. The video may include a continuous sequency of images that the display screen 117 may display in succession. The control circuitry 111 may control the display screen 117 to display the sequency of images at a frame rate. The frame rate may be 10 frames per second (fps), 24 fps, 30 fps, 60 fps, or any other rate. The transceiver 110 may transform the audio streaming into audio signals and the video streaming into video signals when extracting, from the multimedia content, the video streaming and the audio streaming. The transceiver 110 may output the audio signals to the speaker 116 and may output the video signals to the display screen 117.

The control circuitry 111 may control the overall operations of the television 11. The control circuitry 111 may be implemented as any suitable processing circuitry including, but not limited to at least one of a microcontroller, a microprocessor, a single processor, and a multiprocessor. The control circuitry 111 may include at least one of a video scaler integrated circuit (IC), an embedded controller (EC), a central processing unit (CPU), a graphics processing unit (GPU), an accelerated processing unit (APU), an application specific integrated circuit (ASIC), field programmable gate arrays (FPGA), or the like, and may have a plurality of processing cores.

Memory 112 may be a non-transitory processor readable or computer readable storage medium. Memory 112 may store filters, rules, data, or a combination thereof. Memory 112 may comprise read-only memory (“ROM”), random access memory (“RAM”), other non-transitory computer-readable media, or a combination thereof. In some examples, memory 112 may store firmware. Memory 112 may store software for the television 11. The software for the television 11 may include program code. The program code may include program instructions that are readable and executable by the control circuitry 111, also referred to as machine-readable instructions. Memory 112 may be any electronic, magnetic, optical, or other physical storage device that stores executable instructions and/or data.

Sensor circuitry 113 may detect the presence or absence of any person within a target area 121. As illustrated in FIG. 1C, the target area 121 may be the area within a living space 141 in which the display screen 117 is viewable. The living space 141 may be a room. The living space 141 may be any other location within a dwelling. The target area 121 within the living space 141 may be a field of view for the display screen 117. The sensor circuitry 113 may include a motion sensor, a presence sensor, a radio frequency (RF) sensor, an audio sensor, a microphone, an infrared (IR) sensor, an image sensor, an optical sensor, a camera, and/or any other sensor that may detect the presence or absence of the person within the target area 121. The sensor circuitry 113 may comprise one or more sensors.

The user interface 114 may include circuitry that transmits and receives control information that permits a person to interact with the television 11. The user interface 114 may communicate with a remote control unit 19, by wire or wirelessly, to receive control information from the remote control unit 19. The user interface 114 may include a graphical user interface (GUI) that is displayed on the display screen 117. When displayed on the display screen 117, a person may manually input the control information into the GUI. The user interface 114 may include a series of mechanical switches, buttons, and knobs on the television 11 that enables the television 11 to receive the control information from the person manually.

Speaker 116 is a transducer that may receive audio signals from the transceiver 110 and convert the audio signals into audible sounds. The audible sounds are sound that could be heard by the human ear. The audio signals from the transceiver 110 may be electrical signals that are in analog form and/or digital form. An audio link 130 may transfer the audio signals from the transceiver 110 to the speaker 116. The speaker 116 may receive the audio signals from the transceiver 110 via the audio link 130. The speaker 116 may receive, from the control circuitry 111 via the bus 120, audio information that controls the speaker 116 in a manner that causes the speaker 116 to adjust the audible sounds that the speaker 116 emits. The speaker 116 may comprise one or more speakers.

The display screen 117 is an electrical device that may present the video for viewing when the display screen 117 receives the video signals from the transceiver 110. A video link 140 may transfer the video signals from the transceiver 110 to the display screen 117. The display screen 117 may receive the video signals from the transceiver 110 via the video link 140. The display screen 117 may receive the video signals from the transceiver 110 in analog form and/or digital form.

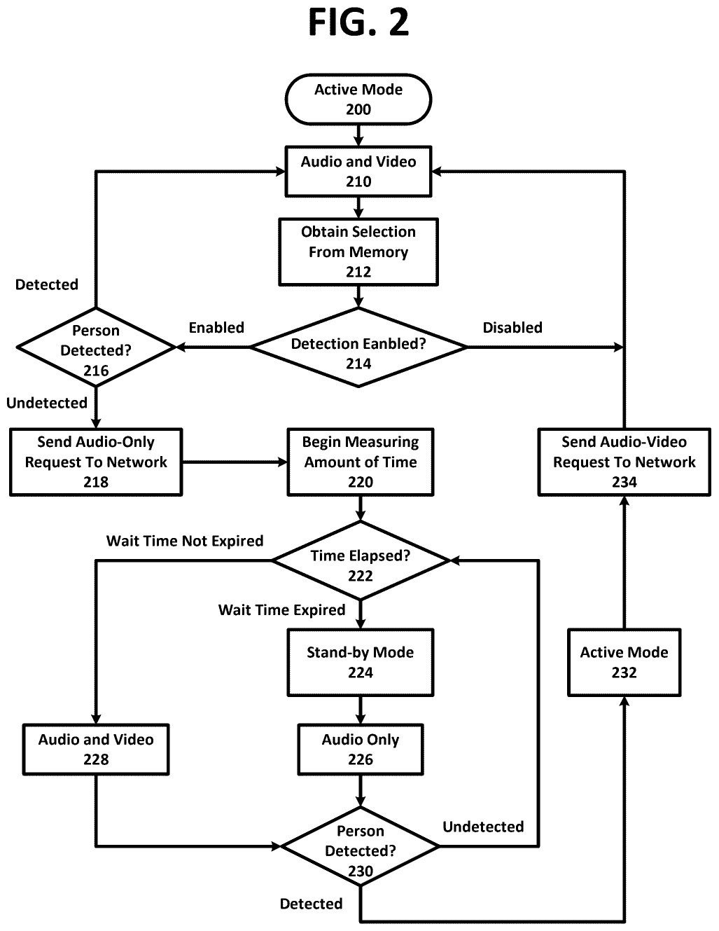

Consistent with the present disclosure, FIG. 2 is an example flowchart that illustrates detection processing by the television 11. FIG. 2 may illustrate an example of presence detection software. The memory 112 may be a non-transitory computer-readable medium storing the presence detection software, which, when executed by the control circuitry 111, causes the control circuitry 111 to perform the presence detection processing of FIG. 2.

Throughout the detection processing of FIG. 2, the control circuitry 111 may control the transceiver 110 to transform the audio streaming into audio signals. When the speaker 116 receives the audio signals from the transceiver 110, the speaker 116 may receive an audio command from the control circuitry 111 via the bus 120. The audio command may control the speaker 116 to convert the audio signals into audible sounds.

The display screen 117 may receive, from the control circuitry 111 via the bus 120, a video command that controls the display screen 117 to place the display screen 117 in either an audio-only mode or an active mode. As will be explained in detail, the control circuitry 111 may control the display screen 117 to place the display screen 117 in the audio-only mode or the active mode.

When controlling the display screen 117 to present the video for viewing, the control circuitry 111 may control the display screen 117 to present the video in sync with the audible sounds. The control circuitry 111 may control the display screen 117 to place the display screen 117 in the active mode. While placing the display screen 117 in the active mode, the control circuitry 111 may control the display screen 117 in a manner that converts the video signals into the video and permits the display screen 117 to present the video for viewing.

The control circuitry 111 may control the display screen 117 in a manner that inhibits the display screen 117 from presenting the video for viewing when placing the display screen 117 in the audio-only mode. For example, the control circuitry 111 may place the display screen 117 in the audio-only mode by controlling the display screen 117 to power-down. When controlling the display screen 117 to power-down, the control circuitry 111 may control the display screen 117 reduce or eliminate the electrical power that the display screen 117 consumes. Powering down the display screen 117 may save the amount of electrical power consumed by the television 11 while in operation. When powering down the display screen 117, the control circuitry 111 may control the power supply 115 to reduce or eliminate the electrical power that the power supply 115 supplies to the display screen 117. The electrical power consumed by the display screen 117 while in the audio-only mode is substantially less that when the display screen 117 is in the active mode.

A presence selection may enable or disable the presence detection feature, as will be explained in detail. By navigating and manipulating the remote control unit 19 and/or by navigating and manipulating the user interface 114, a person may input the presence selection to the television 11 or update the presence selection at any time while the television 11 is operating. The control circuitry 111 may control the storing of the presence selection into the memory 112 when the user interface 114 receives the presence selection.

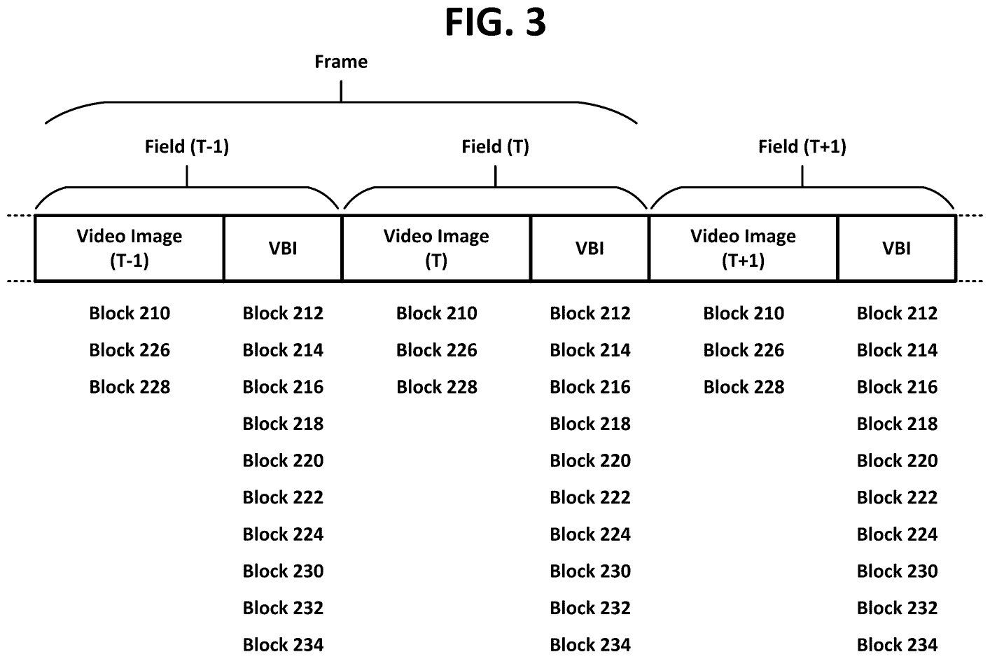

FIG. 3 is an example timing diagram for the detection processing of FIG. 2. Fields (T−1), (T) and (T+1) are illustrated in FIG. 3. Field (T−1) may occur during a time period prior to field (T). Field (T+1) may occur during a time period subsequent to field (T). Although only three fields are depicted in FIG. 3, more than three fields occurring during the detection processing of FIG. 2 is within the scope of the invention. Two of the fields (T−1), (T) and (T+1) is a frame of video.

Each of the fields (T−1), (T) and (T+1) in the example of FIG. 3 may include a video image and a vertical blanking interval (VBI). The vertical blanking interval is a period of time that may occur between one video image and another video image. For example, a vertical blanking interval may occur in FIG. 3 during a time period between video image (T−1) and video image (T). Another vertical blanking interval may occur in FIG. 3 during a time period between video image (T) and video image (T−1). Video image (T−1) may occur during the time period between a vertical blanking interval and yet another vertical blanking interval.

FIG. 3 provides a listing of the process blocks in FIG. 2 that may occur during any of the video images (T−1), (T) and (T+1). FIG. 3 also lists the process blocks in FIG. 2 that may occur during any of the vertical blanking periods.

In FIG. 2, detection processing in the presence detection commences at block 200. The control circuitry 111 may advance the detection processing in FIG. 2 from block 200 to block 210.

In block 210, the control circuitry 111 may control the display screen 117 to remain in the active mode and display at least one of the images in the video. In one example, the control circuitry 111 may control the display screen 117 to display a field of the video with the time period in block 210 being the length of time to complete a field of the video. As another example, the control circuitry 111 may control the display screen 117 to display a frame of the video with the time period in block 210 being the length of time to complete a frame of the video. A vertical blanking interval may be a time period that occurs between the end of one of the video and the beginning of the next successive frame of the video. The control circuitry 111 may in block 210 control the speaker 116 to emit the audible sounds, the audible sounds being in sync with the video. The control circuitry 111 may advance the processing in FIG. 2 from block 210 to block 212.

Block 212 may occur during the video blanking interval that follows the detection processing in block 210. In block 212, the control circuitry 111 may retrieve the presence selection from the memory 112. The control circuitry 111 may advance the processing in FIG. 2 from block 212 to block 214.

Block 214 may occur during the video blanking interval that follows the detection processing in block 210. In block 214, the control circuitry 111 may, after retrieving the presence selection from the memory 112, process the presence selection to determine whether the presence detection feature is enabled or disabled. When the control circuitry 111 determines that the presence detection feature is disabled (“Disabled”), the control circuitry 111 may advance the processing in FIG. 2 from block 214 to block 210. When the control circuitry 111 determines that the presence detection feature is enabled (“Enabled”), the control circuitry 111 may advance the processing in FIG. 2 from block 214 to block 216.

Block 216 may occur during the video blanking interval that follows the detection processing in block 210. In block 216, the control circuitry 111 may send a status request to the sensor circuitry 113 via the bus 120. The status request is a command that controls the sensor circuitry 113 to detect the presence or absence of any person within the target area 121. The sensor circuitry 113 may, when receiving the status request, scan the target area 121 to ascertain the presence or absence of a person within the target area 121. Upon ascertaining the presence or absence of a person within the target area 121, the sensor circuitry 113 may send a detection result to the control circuitry 111 via the bus 120. The detection result indicates whether the sensor circuitry 113 has detected the presence or absence of any person within the target area 121.

Upon retrieving the detection result from the sensor circuitry 113, the control circuitry 111 may in block 216 process the detection result to determine whether or not the detection result indicates detection by the sensor circuitry 113 of a person in the target area 121. When the control circuitry 111 determines that the detection result indicates a presence of a person within the target area 121 (“Detected”), the control circuitry 111 may advance the processing in FIG. 2 from block 216 to block 210. When the control circuitry 111 determines that the detection result indicates an absence of a person in the target area 121 (“Undetected”), the control circuitry 111 may advance the processing in FIG. 2 from block 216 to block 218.

Block 218 may occur during the video blanking interval that follows the detection processing in block 210. In block 218, the control circuitry 111 may control the transceiver 110 to send an audio-only instruction to the communication device 13. When receiving the audio-only instruction from the transceiver 110, the communication device 13 may encode the audio-only instruction into the communication information and upload (or upstream) the communication information to the network 15 so that the network 15 may transmit the audio-only instruction to the third-party service 17. When receiving the audio-only instruction from the network 15, the third-party service 17 may cause the network 15 may transmit the multimedia content from the third-party service 17 to the communication device 13 with the video streaming in the multimedia content. The removal of the video streaming from the multimedia content may reduce the amount of data in the transmission of the multimedia content to the television 11. Reducing the amount of data in the transmission of the multimedia content may reduce the cost for the transmission of the multimedia content to the television 11. The control circuitry 111 may advance the processing in FIG. 2 from block 218 to block 220. Blocks 212, 214, 216, 218 and 220 may occur during the video blanking interval that follows the detection processing in block 210.

In block 220, the control circuitry 111 may extract a wait time from the memory 112. Block 220 may occur during the video blanking interval that follows the detection processing in block 210. As used herein, the wait time is the minimum amount of time that is required between the detection by the sensor circuitry 113 of an absence of a person in the target area 121 and a placement by the control circuitry 111 of the display screen 117 in the audio-only mode. The control circuitry 111 may store the wait time into memory 112 prior to executing the detection processing of FIG. 2. Upon the extraction of the wait time from the memory 112, the control circuitry 111 may commence measuring a span of time that elapses. In some examples, the wait time may be three (3) seconds. In other examples, the wait time may specify an amount of time that is other than three (3) seconds. The control circuitry 111 may advance the processing in FIG. 2 from block 220 to block 222.

In block 222, the control circuitry 111 may ascertain whether or not the wait time has elapsed. Block 222 may occur during the video blanking interval that succeeds the detection processing in block 220. Block 222 may occur during the video blanking interval that precedes the detection processing in block 224. When control circuitry 111 determines in block 222 that the wait time is has not elapsed (“Wait Time Not Expired”), the control circuitry 111 may advance the processing in FIG. 2 from block 222 to block 228. The wait time has not elapsed when the span of time that elapses is less than the wait time. When control circuitry 111 determines in block 222 that the wait time has elapsed (“Wait Time Expired”), the control circuitry 111 may advance the processing in FIG. 2 from block 222 to block 224. The wait time has elapsed when the span of time that elapses is equal to or greater than the wait time.

In block 224, the control circuitry 111 may control the display screen 117 to place the display screen 117 in the audio-only mode. To place the display screen 117 in the audio-only mode, the control circuitry 111 may control the display screen 117 to inhibit the display screen 117 from presenting the video for viewing. The control circuitry 111 may advance the processing in FIG. 2 from block 224 to block 226. Block 224 may occur during the video blanking interval that precedes the detection processing in block 226.

In block 226, the control circuitry 111 may control the display screen 117 to remain in the audio-only mode. While the display screen 117 is in the audio-only mode, the control circuitry 111 may in block 226 control the speaker 116 to emit the audible sounds. The control circuitry 111 may advance the processing in FIG. 2 from block 226 to block 230. Block 230 may occur during the video blanking interval that follows the detection processing in block 226.

Block 222 may occur during the video blanking interval that precedes the detection processing in block 228. In block 228, the control circuitry 111 may control the display screen 117 to display at least one of the images in the video. In one example, the control circuitry 111 may control the display screen 117 to display a field of the video with the time period in block 228 being the length of time to complete a field of the video. As another example, the control circuitry 111 may control the display screen 117 to display a frame of the video with the time period in block 228 being the length of time to complete a frame of the video. The control circuitry 111 may in block 228 control the speaker 116 to emit the audible sounds, the audible sounds being in sync with the video. The control circuitry 111 may advance the processing in FIG. 2 from block 228 to block 230. Block 230 may occur during the video blanking interval that follows the detection processing in block 228.

In block 230, the control circuitry 111 may send a status request to the sensor circuitry 113 via the bus 120. The status request is a command that controls the sensor circuitry 113 to detect the presence or absence of any person within the target area 121. The sensor circuitry 113 may, when receiving the status request, scan the target area 121 to ascertain the presence or absence of a person within the target area 121. Upon ascertaining the presence or absence of a person within the target area 121, the sensor circuitry 113 may send a detection result to the control circuitry 111 via the bus 120. The detection result indicates whether the sensor circuitry 113 has detected the presence or absence of any person within the target area 121.

Upon retrieving the detection result from the sensor circuitry 113, the control circuitry 111 may in block 230 process the detection result to determine whether or not the detection result indicates detection by the sensor circuitry 113 of a person in the target area 121. When the control circuitry 111 determines that the detection result indicates an absence of a person in the target area 121 (“Undetected”), the control circuitry 111 may advance the processing in FIG. 2 from block 230 to block 222. When the control circuitry 111 determines that the detection result indicates a presence of a person within the target area 121 (“Detected”), the control circuitry 111 may advance the processing in FIG. 2 from block 230 to block 232. Block 230 may occur during the video blanking interval that precedes the detection processing in block 232.

In block 232, the control circuitry 111 may control the display screen 117 to place the display screen 117 in the active mode. When placing the display screen 117 in the active mode, the control circuitry 111 may permit the display screen 117 to present the video for viewing. The control circuitry 111 may advance the processing in FIG. 2 from block 232 to block 234.

In block 234, the control circuitry 111 may control the transceiver 110 to send an audio-video request to the communication device 13. When receiving the audio-video request from the transceiver 110, the communication device 13 may encode the audio-video request into the communication information and upload (or upstream) the communication information to the network 15 so that the network 15 may transmit the audio-video request to the third-party service 17. When receiving the audio-video request from the network 15, the third-party service 17 may cause the network 15 may transmit the multimedia content from the third-party service 17 to the communication device 13 with the video streaming and the audio streaming in the multimedia content. The control circuitry 111 may advance the processing in FIG. 2 from block 234 to block 210. Block 234 may occur during the video blanking interval that precedes the detection processing in block 210.

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single-or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein.

Accordingly, for example, examples of the technology may be implemented as a set of instructions, tangibly embodied on a non-transitory computer-readable media, such that a processor may implement the instructions based upon reading the instructions from the computer-readable media. Some examples of the technology may include (or utilize) a control device such as, e.g., an automation device, a special purpose or programmable computer including various computer hardware, software, firmware, and so on, consistent with the discussion herein. As specific examples, a control device may include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, may be executed in different orders than are expressly illustrated or described, as appropriate for particular examples of the technology. Further, in some examples, certain operations may be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. A component (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that may be present in any variety of combinations, rather than an exclusive list of components that may be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; Band C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

In the description above and the claims below, the term “connected” may refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “the communication,” “interaction” and their variations include at least one of: (i) transmitting of information to a device or system; or (ii) receiving of information by a device or system.

Any mark, if referenced herein, may be common law or registered trademarks of third parties affiliated or unaffiliated with the applicant or the assignee. Use of these marks is by way of example and shall not be construed as descriptive or to limit the scope of disclosed or claimed embodiments to material associated only with such marks.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the application, ordinal numbers (e.g., first, second, third, etc.) may be used as an adjective for an element (i.e., any noun in the application). Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section.

The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application.

Unless otherwise indicated, like parts and method steps are referred to with like reference numerals.

Although the present technology has been described by referring to certain examples, workers skilled in the art will recognize that changes may be made in form and detail without departing from the scope of the discussion.

What is claimed is:

1. An electronic apparatus comprising:
a display screen configured to:
convert, when receiving video signals, the video signals into video;
a speaker configured to:
convert, when receiving audio signals, the audio signals into audible sounds;
sensor circuitry configured to:
detect, when the electronic apparatus is within a target area, a presence or absence of any person within the target area; and
control circuitry configured to:
permit, when the sensor circuitry detects the absence of any person within the target area, the speaker to emit the audible sounds, and
inhibit, when the sensor circuitry detects the absence of any person within the target area, the display screen from presenting the video for viewing.

2. The electronic apparatus of claim 1, wherein the control circuitry is configured to:
inhibit, when permitting the speaker to emit the audible sounds, the display screen from presenting the video for viewing.

3. The electronic apparatus of claim 1, wherein the control circuitry is configured to:
control, when inhibiting the display screen from presenting the video for viewing, the display screen to power-down.

4. The electronic apparatus of claim 1, wherein the control circuitry is configured to:
permit, when the sensor circuitry detects the presence of any person within the target area, the display screen to present the video for viewing.

5. The electronic apparatus of claim 1, wherein the control circuitry is configured to:
permit, when the sensor circuitry detects the presence of any person within the target area, the speaker to emit the audible sounds.

6. The electronic apparatus of claim 1, wherein the control circuitry is configured to:
control, when the sensor circuitry detects the absence of any person within the target area, a transceiver to output an audio-only instruction that requests removal of video streaming from multimedia content.

7. The electronic apparatus of claim 6, wherein the transceiver is configured to:
convert, when extracting the video streaming from the multimedia content, the video streaming into the video signals.

8. The electronic apparatus of claim 6, wherein the transceiver is configured to:
convert, when extracting audio streaming from the multimedia content, the audio streaming into the audio signals.

9. The electronic apparatus of claim 6, wherein the control circuitry is configured to:
commence, when the transceiver outputs the audio-only instruction, measuring a span of time that elapses from when the transceiver outputs the audio-only instruction.

10. The electronic apparatus of claim 9, wherein the control circuitry is configured to:
inhibit, when the span of time is equal to or greater than a predetermined wait time, the display screen from presenting the video for viewing.

11. The electronic apparatus of claim 10, wherein the control circuitry is configured to:
permit, when the span of time is less than the predetermined wait time, the display screen to present the video for viewing.

12. The electronic apparatus of claim 6, wherein the transceiver is configured to:
send, through a communication device, the audio-only instruction to a third-party service.

13. The electronic apparatus of claim 12, wherein the transceiver is configured to:
receive, through the communication device, the multimedia content from the third-party service.

14. The electronic apparatus of claim 12, wherein the third-party service is configured to:
remove, when receiving the audio-only instruction, the video streaming from the multimedia content.

15. The electronic apparatus of claim 14, wherein the third-party service is configured to:
send, when removing the video streaming from the multimedia content, the multimedia content without the video streaming in the multimedia content.

16. A method comprising:
converting, by a display screen of an electronic apparatus when the display screen receives video signals, the video signals into video;
converting, by a speaker of the electronic apparatus when the speaker receives audio signals, the audio signals into audible sounds;
detecting, by sensor circuitry of the electronic apparatus when the electronic apparatus is within a target area, a presence or absence of any person within the target area;
permitting, by control circuitry of the electronic apparatus when the sensor circuitry detects the absence of any person within the target area, the speaker to emit the audible sounds; and
inhibiting, by the control circuitry when the sensor circuitry detects the absence of any person within the target area, the display screen from presenting the video for viewing.

17. The method of claim 16, further comprising:
inhibiting, by the control circuitry when the control circuitry permits the speaker to emit the audible sounds, the display screen from presenting the video for viewing.

18. The method of claim 16, further comprising:
permitting, by the control circuitry when the sensor circuitry detects the presence of any person within the target area, the display screen to present the video for viewing.

19. A non-transitory computer-readable medium on which is stored instructions that when executed by a processor, cause the processor to:
control sensor circuitry of an electronic apparatus to:
detect, when the electronic apparatus is within a target area, a presence or absence of any person within the target area;
control a speaker of the electronic apparatus to:
convert, when the speaker receives audio signals, the audio signals into audible sounds, and
permit, when the sensor circuitry detects the absence of any person within the target area, the speaker to emit the audible sounds; and
control a display screen of the electronic apparatus to:
convert, when the display screen receives video signals, the video signals into video, and
inhibit, when the sensor circuitry detects the absence of any person within the target area, the display screen from presenting the video for viewing.

20. The non-transitory computer-readable medium of claim 19 on which is stored instructions that when executed by the processor, cause the processor to:
inhibit, when permitting the speaker to emit the audible sounds, the display screen from presenting the video for viewing.
